(19) United States
(12) Patent Application Publication
(10) Pub. No.: US 2026/0331320 A1
(43) Pub. Date: Oct. 22, 2026

(54) SHIELDED RADIOPHARMACEUTICAL TRANSPORT CONTAINER

(71) Applicant: Jubilant DraxImage, Inc., Yardley, PA (US)

(72) Inventors: Carl H. Riley, Mount Pleasant, SC (US); James Miles, Pocatello, ID (US)

(21) Appl. No.: 19/649,216

(22) Filed: Apr. 16, 2026

Related U.S. Application Data
(60) Provisional application No. 63/790,572, filed on Apr. 17, 2025.

(51) Int. Cl. G21F 5/015; G21F 5/08; G21F 5/12

(52) U.S. Cl. CPC G21F 5/015; G21F 5/08; G21F 5/12

(57) ABSTRACT

The present invention discloses a double shielded radiopharmaceutical container device containing radiopharmaceutical drugs. More particularly, the present invention relates to a double shielded container for containing radiopharmaceutical drugs comprising: a primary shielding container with a cap and a handle; and a secondary shielding container with a cap and a handle; wherein the secondary shielding container encloses the primary shielding container; and wherein the primary shielding container is easily removable from the secondary shielding container, preventing an operator from the need to lift the secondary shielding container. The double shielded container device as per the present invention facilitates the safe use and safe transport of radiopharmaceuticals by avoiding undesirable radiation exposure to the user and patient.

### TECHNICAL FIELD

The present invention relates in general to radiopharmaceutical and nuclear medicine, and especially relates to a radiopharmaceutical shielded transport container used in radiopharmacies to address radiation hazard safety.

### BACKGROUND

Hazardous substance like radiopharmaceutical drugs are carefully, safely packed and transported to reduce undesirable exposure of the product to the end user. The radioactive content can be extremely high for the operator during manufacturing and handling of these products. The transporting and packaging container used for radiopharmaceuticals consists of lead, tungsten and other radiation protection materials, which have a high density and provides excellent shielding properties against gamma and beta emitting radiopharmaceuticals.

The container containing the radiopharmaceutical drugs or dose is shipped to the destination hospital or clinic for administration to the patient. To safely transport the dose, the container is enclosed within a radioactivity-shielding container to minimize the undesirable radiation hazard and for interim storage and safe delivery to the destination. Once the radiopharmaceutical container is placed into the radiopharmaceutical compartment and the pig assembled, the pig is ready to be shipped to the patient's location.

According to the existing regulations governed by the United States, including the Department of Transportation (DOT), the Nuclear Regulatory Commission, and the Occupational Health and Safety Administration, radioactive drugs are required to be transported in a shielded container. These radioactive drugs have undesirable and hazardous radiation exposure to the user, professionals, patients, as well as the driver or courier. These radiopharmaceutical drugs are mostly available in liquid form, are kept in vials, and pre-filled syringes, which are difficult to transport safely without any damage. The vials and pre-filled syringes are securely kept in a shielded container, made up of lead-like materials and are extremely heavy in weight. Radiopharmaceutical drugs, which are packaged in vials or pre-filled syringes, are further radiolabeled with radioisotopes having long and short half-lives like F-18, Lu-177, Ac-225, Cu-64, Ga-68, I-131, Tc-99m. The said shielded containers have the ability to provide protection to the professionals, patients, and users from undesirable radiation exposure, emitted from radioisotopes like alpha emission, beta emission, and gamma emission. However, conventional shielded containers are not appropriately sized to accommodate the vials or pre-filled syringes for the transportation of radiopharmaceutical drugs. The shielded containers are heavy, which results in difficulty in handling and can prevent a user from lifting such bulky and heavy shielded containers, loaded with radioactive material, onto a working table. Further, these containers are mostly non-compliant with quality assurance tests like freefall drop and shock testing, vibration testing, concentrated impacts, compression (vehicle and warehouse), incline impact testing, cold chain testing for temperature and humidity inputs, high and low pressure (altitude) inputs testing, loose load/mechanical bounce testing, and rough forklift handling. Therefore, there is an unmet need to develop a shielded transportation container that is radiation protected and double shielded for easy transportation, strong enough to handle the heavy weight of the transportation shield, and compliant to the quality assurance tests as recommended by the ASTM and ISTA standards. Unless properly shielded, radiopharmaceutical products become a radiation hazard for individuals handling the product.

### SUMMARY

The present invention provides a double shielded radiopharmaceutical container for transporting radiopharmaceutical drugs packed in a vial, syringe or any other suitable container. The double shielded container for transporting radiopharmaceutical drugs comprises a primary shielding container, which is made of a radiation protection material(s) like lead, tungsten, and other radiation shielding materials. Particularly, the present invention relates to a double shielded container for transporting radiopharmaceutical drugs comprising a secondary shielding container, which accommodates the primary shielding container within it. The primary shielding container and the secondary shielding container both have a cap to enclose the shielded containers.

The object of the present invention is to provide a double shielded container for transporting radiopharmaceutical drugs with the primary shielding container and the secondary shielding container, both having a cap to enclose the shielded containers, wherein the cap of both of the containers have a handle to lift.

The object of the present invention is to provide a double shielded container for safely transporting radiopharmaceutical drugs, comprising a primary shielding container and a secondary shielding container, wherein the primary shielding container facilitates easy handling and avoids a user from undesirable lifting of a heavy secondary shielding container. Conversely, as per the present invention the user has to lift a much smaller weight to provide radiation protection from the radioactive material within the primary shielding container.

An aspect of the present invention is to provide a double shielded container for transporting radiopharmaceutical drugs, comprising:
a primary shielding container with a closure cap and a handle; and
a secondary shielding container with a closure cap and a handle;
   wherein the secondary shielding container encloses the primary shielding container; and
   wherein the primary shielding container is easily removable from the secondary shielding container, preventing the need to lift the secondary shielding container.

An aspect of the present invention is to provide a double shielded container for transporting radiopharmaceutical drugs, comprising:
a primary shielding container with a closure cap and a handle on it; and
a secondary shielding container with a closure cap and a handle;
   wherein the secondary shielding container encloses the primary shielding container;
   wherein the primary shielding container is easily removable from the secondary shielding container, preventing the need to lift the secondary shielding container; and
   wherein the secondary shielding container comprises a monitoring system to monitor the double shielded container for the transportation of radiopharmaceutical drugs.

An aspect of the present invention is to provide a transporting box for transportation of radiopharmaceutical drugs, comprising a double shielded container, wherein the double shielded container comprises:
a primary shielding container with a cap and a handle on the cap; and
a secondary shielding container with a cap and a handle to lift;
   wherein the primary shielding container is enclosed within the secondary shielding container, and the secondary shielding container is further surrounded with a foam packing and enclosed in a transporting box;
   wherein the primary shielding container is easily removable from the secondary shielding container, preventing the need to lift the secondary shielding container; and
   wherein the secondary shielding container comprises a monitoring system to monitor the transporting shielding system.

### BRIEF DESCRIPTION OF DRAWINGS

Further features and advantages of the present invention will become apparent from the following detailed description, taken in combination with the appended drawings, in which:

FIG. 1 shows a diagram of a schematic representation of a secondary shielding container for transportation of radiopharmaceutical drugs.

FIG. 2 shows a diagram of a schematic representation of a primary shielding container, which is configured to enclose the vial with the cap and closure.

FIG. 3 shows a diagram of a schematic representation of the entire arrangement of the double shielded container for transporting radiopharmaceutical drugs, which further encloses a vial for transportation.

FIG. 4 shows a diagram of a schematic representation of the entire arrangement of the double shielded container for transporting radiopharmaceutical drugs, which comprises the primary shielding container and the secondary shielding container, and encloses a radiopharmaceutical drugs vial, wherein both the shielded containers (primary and secondary) are enclosed with caps along with handles to lift the container.

FIG. 5 illustrates a schematic representation of a cap and closure system.

FIG. 6 illustrates a schematic representation of a rim system.

### DETAILED DESCRIPTION

The present invention can be more readily understood by reading the following detailed description of the invention and included embodiments.

The term “about” as used herein in the invention refers to a measurable value such as a parameter, an amount, a temporal duration, and the like, and is meant to encompass variations of and from the specified value, in particular variations of ±10% or less, preferably ±5% or less from the specified value, such variations are appropriate to perform in the disclosed invention. It is to be understood that the value to which the modifier “about” refers is itself also specifically, and preferably, disclosed.

As used in the specification of the present invention, the singular forms “a”, “an”, and “the” include plural references unless the context clearly dictates otherwise. Thus, for example, a reference to “a system” or “a device” or “a process” or “a composition” includes one or more systems, one or more device, one or more process or composition, with one or more steps or ingredients or elements of the type described herein and/or which will become apparent to those persons skilled in the art upon reading this disclosure and so forth.

As used herein, the term “radionuclide” or “radioisotope” refers to an unstable form of a chemical element that releases radiation as it breaks down and becomes more stable. Radionuclides can occur in nature or can be generated in a laboratory. In medicine, they are used in imaging tests and/or in treatment.

As used herein, the term “transportation shield” refers to a protective container used to safely transport hazardous materials, such as radiopharmaceutical drugs. These shields are designed to protect against radiation and block harmful radiation, ensure durability to withstand physical impacts and environmental conditions during transportation and comply with regulations to meet stringent safety standards set by regulatory bodies to ensure safe handling and transport.

As used herein, the term “primary shield” refers to the first shielded container, which holds the radiopharmaceutical drug vial and has a direct contact with the vial. The primary shielding container is enclosed by the secondary shielding container. The primary shielding container comprises a cap and closure system along with a handle to lift the primary shielding container above the working table. The primary shielding container is also shielded with radiation shielding materials known in the art or like to protect against radiation and block harmful radiation, and ensure durability to withstand physical impacts and environmental conditions during transportation. The word herein “primary shield” is synonymous with “primary transportation shield” or “primary shield” or “primary shielding container” as applicable.

As used herein, the term “secondary shield” refers to the second shielded container, which encloses the primary shielding container/pig to protect against radiation and block harmful radiation, and ensure durability to withstand physical impacts and environmental conditions during transportation. The said secondary shield also comprises a cap and closure for further safety and has a handle system to lift during the transportation and other process. The word herein “secondary shield” is synonymous with “secondary transportation shield” or “secondary shield” or “secondary shielding container” as applicable.

As used herein, the term “monitoring system” refers to such monitoring system, which can identify the RFID (Radio Frequency Identification) Systems; sensors; and Wireless Transmitter Systems. Further, the RFID technology uses radio waves to automatically identify and track tags attached to objects. These systems consist of tags (small devices with a microchip and antenna), readers in devices that emit radio waves to communicate with tags and capture their data; and software to manage and store the data collected by the readers. Sensor monitoring systems are used to monitor various environmental and operational parameters. Wireless Transmitter systems send data from sensors or other devices to a central system without the need for physical connections. These wireless transmitter system can immediately send the alert to the user or user interface of an unauthorized intervention. These systems can be integrated to provide comprehensive monitoring solutions for various applications, from industrial automation to healthcare.

As used herein, the term “encoded information” refers to information, which can be understood by an encoded information reader. Further, the encoded information reader is a device or software used to interpret and extract data from encoded formats, such as barcodes, QR codes, Bluetooth Low Energy (BLE), Near-Field Communication (NFC), Wi-Fi, Ultra-Wide Band (UWB), and GPS Tracking, or other machine-readable symbols. Some common types are selected from the group consisting of QR Code Reader to scan QR codes to retrieve information like URLs, contact details, or text of the manufacturer, thickness, density, tests passed, or combinations thereof; barcode scanner, reads barcodes to identify products and retrieve associated data, commonly used in retail and inventory management; and optical character recognition (OCR), converts images of text into machine-encoded text, useful for digitizing printed documents.

As used herein, the term “twist-lock element” refers to twist-lock recesses, which refer to specially designed indentations or slots in a twist-lock receptacle or connector. These recesses are part of the locking mechanism that ensures a secure and reliable connection between the plug and the receptacle such as insertion and rotation, wherein the plug is inserted into the receptacle, aligning its prongs or blades with the corresponding slots in the recesses; twist to lock, wherein once inserted, the plug is twisted, typically clockwise, to engage the locking mechanism. This twist causes the prongs to latch into the recesses, creating a secure connection; and secure connection by the locking mechanism, which prevents accidental disconnections, making twist-lock connectors ideal for environments where safety and reliability are crucial. This “twist-lock” element will ensure the vial's safety and will protect from leaching or leaking outside, avoiding unnecessary exposure to radiation by the user during transportation and handling.

As used herein, the term “hard plastic material” refers to hard plastic, which refers to a type of plastic that is rigid and cannot be easily dented, crushed, or pierced and easy for transportation because of their durability and strength. Hard plastic material can be selected from the group consisting of vinyl polymer, polyamide-imide (PAI), polyether ether ketone (PEEK), polyphenylene sulfide (PPS), nylon, high-density polyethylene (HDPE), polycarbonate (PC), Polyethylene Terephthalate (PET), and/or combinations thereof. Hard plastics are often used in applications where structural integrity and resistance to impact are crucial.

As used herein, the term “radiation shielding” refers to the use of materials and techniques to protect people, equipment, and the environment from the harmful effects of ionizing radiation by absorbing or blocking the radiation. Radiation shielding is necessary in nuclear medicine field during diagnosis, medical imaging, therapy, infusion or administration to patients, elution and production of radioisotopes to be infused to patients.

As used herein, the term “quality tests” is synonymous with “quality control tests” or “quality assurance tests”, which is a process that helps companies ensure their products reach designated standards. According to the ASTM and ISTA standards, the present invention includes a double shielded container for transporting radiopharmaceutical drugs, which is compliant to the quality control tests, selected from the group consisting of freefall drop and shock testing, vibration testing, concentrated impacts testing, compression testing, incline impact testing, cold chain testing for temperature and humidity inputs, high and low pressure inputs testing, loose load or mechanical bounce testing, rough forklift handling testing and combinations thereof.

The present invention includes a double shielded container for containing radiopharmaceutical drugs, comprising a primary shielding container and a secondary shielding container, both having a cap to enclose the containers, wherein the cap of both the containers has a handle to lift the respective container.

Further, the invention relates to a double shielded container for transporting radiopharmaceutical drugs, comprising a primary shielding container and a secondary shielding container, wherein the primary shielding container is configured to facilitate easy handling, preventing a user from having to lift a secondary shielding container when loaded with radioactive material onto a table. Instead, users are required to lift a much smaller weight (i.e., the primary shielding container) to provide radiation protection.

An embodiment of the present invention includes a double shielded container for transporting radiopharmaceutical drugs, comprising:
a primary shielding container with a closure cap and a handle; and
a secondary shielding container with a closure cap and a handle;
wherein the secondary shielding container encloses the primary shielding container; and
wherein the primary shielding container is easily removable, preventing the need for the operator to lift the secondary shielding container.

An embodiment of the present invention provides a double shielded container for transporting radiopharmaceutical drugs, comprising:
a primary shielding container with a closure cap and a handle on it; and
a secondary shielding container with a closure cap and a handle;
wherein the secondary shielding container encloses the primary shielding container;
wherein the primary shielding container further encloses a radiopharmaceutical drug dose in a vial or a pre-filled syringe; and
wherein the secondary shielding container comprises a monitoring system to monitor the double shielded container for the transportation of radiopharmaceutical drugs.

An embodiment of the present invention includes the double shielded container for transporting radiopharmaceutical drugs, wherein the secondary shielding container is surrounded with a foam packing and further enclosed in a transporting box.

An embodiment of the present invention includes the double shielded container for transporting radiopharmaceutical drugs, wherein the secondary shielding container comprises a monitoring system to monitor the double shielded container.

An embodiment of the present invention includes the double shielded container for transporting radiopharmaceutical drugs, wherein the secondary shielding container comprises an encoded information.

An embodiment of the present invention includes the double shielded container for transporting radiopharmaceutical drugs, wherein the primary shielding container comprises a closure cap, a collar, and a rim.

An embodiment of the present invention includes the double shielded container for transporting radiopharmaceutical drugs, wherein the collar comprises one or more flanges and the rim comprises one or more recesses.

An embodiment of the present invention includes the double shielded container for transporting radiopharmaceutical drugs, wherein the recess is designed to releasably engage with the flange.

An embodiment of the present invention includes the double shielded container for transporting radiopharmaceutical drugs, wherein the flange functions as a twist-lock element that is received by one or more twist-lock recesses in the flange of the primary shielding container.

Another embodiment of the present invention includes the double shielded container for transporting radiopharmaceutical drugs, wherein the twist-lock recesses, when twisted, helps to secure the closure cap locked tightly to the primary shielding container and the closure cap is engaged with the primary shielding container.

An embodiment of the present invention includes a double shielded container for transporting radiopharmaceutical drugs, wherein the invention includes a double shielded container for transporting radiopharmaceutical drugs, comprising:
a primary shielding container with a closure cap and a handle on it; and
a secondary shielding container with a closure cap and a handle;
wherein the secondary shielding container encloses the primary shielding container;
wherein the primary shielding container further encloses a radiopharmaceutical drug dose in a vial or a pre-filled syringe;
wherein the secondary shielding container comprises a monitoring system to monitor the double shielded container for the transportation of radiopharmaceutical drugs; and
wherein the monitoring system is selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking.

An embodiment of the present invention includes the double shielded container for transporting radiopharmaceutical drugs, wherein the monitoring system comprises RFID tags, sensors, and other wireless transmitter.

An embodiment of the present invention includes the double shielded container for transporting radiopharmaceutical drugs, wherein the monitoring system is selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking.

An embodiment of the present invention includes the double shielded container for transporting radiopharmaceutical drugs, wherein the transporting box is made of hard plastic material.

An embodiment of the present invention includes the double shielded container for transporting radiopharmaceutical drugs, wherein the hard plastic material can be selected from the group consisting of vinyl polymer, polyamide-imide (PAI), polyether ether ketone (PEEK), polyphenylene sulfide (PPS), nylon, high-density polyethylene (HDPE), polycarbonate (PC), or combinations thereof.

An embodiment of the present invention includes the double shielded container for transporting radiopharmaceutical drugs, wherein the shield is made of lead, lead glass, tungsten, cast-iron, lead-containing plastic material, tantalum, charged compound, leaded acrylic/plastic, lead-free acrylic, bismuth, a combination of stainless steel, aluminum alloy and tungsten, or combinations thereof, preferably the shield is made of lead, lead glass, tungsten, aluminum alloy and tungsten, lead-containing plastic material, or combinations thereof, more preferably the shield is made of tungsten, lead, lead glass, or combinations thereof.

An embodiment of the present invention includes the double shielded container for transporting radiopharmaceutical drugs, wherein the double shielded container is compliant to the quality tests selected from the group consisting of freefall drop and shock testing, vibration testing, concentrated impacts testing, compression testing, incline impact testing, cold chain testing for temperature and humidity inputs, high and low pressure inputs testing, loose load or mechanical bounce testing, rough forklift handling testing and combinations thereof.

An embodiment of the present invention includes the double shielded container for transporting radiopharmaceutical drugs, wherein the primary shielding container and secondary shielding container are in the shape of a cylindrical shell.

An embodiment of the present invention includes the double shielded container for transporting radiopharmaceutical drugs, wherein primary shielding container is in the shape of a cylindrical shell with an interior diameter that is only slightly larger than a diameter of the vial that is to be placed into the primary shielding container.

An embodiment of the present invention includes the double shielded container for transporting radiopharmaceutical drugs, wherein the secondary shielding container is in the shape of a cylindrical shell with an interior diameter that is slightly larger than the diameter of the primary shielding container to be enclosed.

An embodiment of the present invention includes the double shielded container for transporting radiopharmaceutical drugs, wherein the diameter of the primary shielding container ranges from 3 inch to 5 inch.

An embodiment of the present invention includes the double shielded container for transporting radiopharmaceutical drugs, wherein the diameter of the secondary shielding container ranges from 4 inch to 6 inch.

An embodiment of the present invention includes a transporting box for transportation of radiopharmaceutical drugs, comprising a double shielded container that comprises:
a primary shielding container with a cap and a handle on the cap; and
a secondary shielding container with a cap and a handle to lift;
wherein the primary shielding container is enclosed within the secondary shielding container, and the secondary shielding container is further surrounded with a foam packing and enclosed in a transporting box;
wherein the primary shielding container is easily removable, preventing the need for the operator to lift the secondary shielding container; and
wherein the secondary shielding container comprises a monitoring system to monitor the transporting shielding system.

An embodiment of the present invention includes a transporting box for transportation of radiopharmaceutical drugs, comprising: a double shielded container comprises:
a primary shielding container with a cap and a handle on the cap; and
a secondary shielding container with a cap and a handle to lift;
wherein the primary shielding container is enclosed within the secondary shielding container, and the secondary shielding container is further surrounded with a foam packing and enclosed in a transporting box;
wherein the primary shielding container further encloses a radiopharmaceutical drug dose in a vial or a pre-filled syringe;
wherein the secondary shielding container comprises a monitoring system to monitor the transporting shielding system;
wherein the monitoring system comprising one or more components selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking; and
wherein the double shielded container is compliant to the quality tests selected from the group consisting of freefall drop and shock testing, vibration testing, concentrated impacts testing, compression testing, incline impact testing, cold chain testing for temperature and humidity inputs, high and low pressure inputs testing, loose load or mechanical bounce testing, rough forklift handling testing and combinations thereof.

An embodiment of the present invention includes the double shielded container or pig for transporting radiopharmaceutical drugs, wherein the pig can be used for any type of radioisotope for diagnostics, therapeutics and theranostics. These types of containers can protect the professionals, patients, and users from undesirable radiation exposure emitted from radioisotopes like alpha emission, beta emission, gamma emission or the like.

An embodiment of the present invention includes the double shielded container for transporting radiopharmaceutical drugs, wherein the double shielded container is configured to safely transport the radioisotope or radionuclide, which is selected from the group consisting of copper-64, copper-67, gallium-68, gallium-67, gallium-66, lutetium-177, yttrium-86, yttrium-90, technetium-99m, indium-111, scandium-47, scandium-44, scandium-43, zirconium-89, bismuth-212, actinium-225, astatine-211, lead-212, rhenium-188, rhenium-186, rubidium-82, and/or combinations thereof.

An embodiment of the present invention include an integrated double shielded container for transporting radiopharmaceutical drugs, comprising:
a primary shielding container with a closure cap and a handle; and
a secondary shielding container with a closure cap and a handle;
wherein the secondary shielding container encloses the primary shielding container;
wherein the primary shielding container further encloses a radiopharmaceutical drug vial configured to contain a radiopharmaceutical dose in the vial;
wherein the secondary shielding container comprises a monitoring system to monitor the double shielded container for the transportation of radiopharmaceutical drugs;
wherein the monitoring system is selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking; and
wherein the double shielded container is accommodated within an impact absorbing intermediate structure in order to protect the radiopharmaceutical drug containing vial or pre-filled syringe during transport.

An embodiment of the present invention includes the double shielded container for transporting radiopharmaceutical drugs, wherein at least a portion or all of the secondary shielding container is surrounded with an impact absorbing intermediate structure.

An embodiment of the present invention includes the double shielded container for transporting radiopharmaceutical drugs, wherein the impact absorbing intermediate structure is a foam packing structure and further enclosed in a transporting box.

An embodiment of the present invention include a double shielded container for transporting radiopharmaceutical drugs, comprising:
a primary shielding container with a closure cap and a handle;
a secondary shielding container with a closure cap and a handle; and
an impact absorbing intermediate structure to accommodate the double shielded container;
wherein the secondary shielding container encloses the primary shielding container;
wherein the primary shielding container further encloses a radiopharmaceutical drug dose vial configured to contain a radiopharmaceutical drug dose within the vial; and
wherein the secondary shielding container comprises a monitoring system to monitor the double shielded container for the transportation of radiopharmaceutical drugs.

An embodiment of the present invention includes an integrated transporting box for transportation of radiopharmaceutical drugs, comprising: a double shielded container comprises:
a primary shielding container with a cap and a handle on the cap;
a secondary shielding container with a cap and a handle to lift; and
an impact absorbing intermediate structure;
wherein the primary shielding container is enclosed with the secondary shielding container, and at least a portion or all of the secondary shielding container is surrounded with the impact absorbing intermediate structure in order to protect the radiopharmaceutical drug containing vial or pre-filled syringe during transport and further enclosed in a transporting box;
wherein the primary shielding container further encloses a radiopharmaceutical drug dose vial configured to contain a radiopharmaceutical drug dose in the vial;
wherein the secondary shielding container comprises a monitoring system to monitor the transporting shielding system;
wherein the monitoring system comprising one or more components selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking; and
wherein the double shielded container is compliant to one or more quality tests selected from the group consisting of freefall drop and shock testing, vibration testing, concentrated impacts testing, compression testing, incline impact testing, cold chain testing for temperature and humidity inputs, high and low pressure inputs testing, loose load or mechanical bounce testing, rough forklift handling testing and combinations thereof.

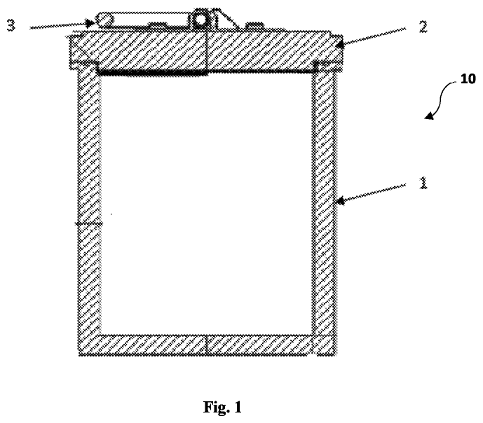

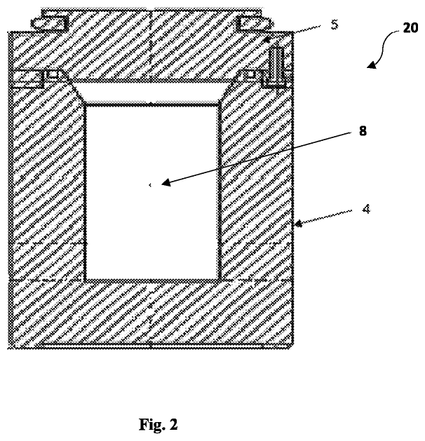

FIG. 1 shows a diagram of a schematic representation of secondary shielding container (10) for transportation of radiopharmaceutical drugs. The secondary shielded wall (1) is made of a radiation protection material, which is selected from the group consisting of lead, lead glass, tungsten, cast-iron, lead-containing plastic material, tantalum, charged compound, leaded acrylic/plastic, lead-free acrylic, bismuth, a combination of stainless steel, aluminum alloy and tungsten, or combinations thereof. The secondary shielding container for transporting radiopharmaceutical drugs has a cylindrical hollow space to accommodate the primary shielding container (20) as shown in FIG. 2. A cap (2) with handle (3) encloses the secondary shielding container. The cap (2) is lifted with the help of the handle (3) to open the secondary shielding container (10).

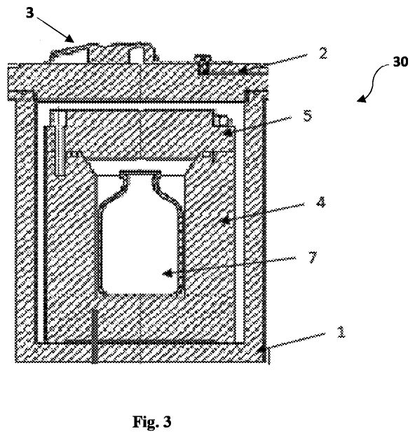

FIG. 2 shows a diagram of a schematic representation of primary shielding container (20), which is used to enclose the vial (7) as shown in FIG. 3 with the cap and closure system (5). The primary shielding container (20) comprises a wall (4), which is made of radiation protection material selected from the group consisting of lead, lead glass, tungsten, cast-iron, lead-containing plastic material, tantalum, charged compound, leaded acrylic/plastic, lead-free acrylic, bismuth, a combination of stainless steel, aluminum alloy and tungsten, or combinations thereof; and a cap and closure system (5). The primary shielding container (20) for transporting radiopharmaceutical drugs has a cylindrical hollow space (8) to accommodate the vial (7) as shown in FIG. 3.

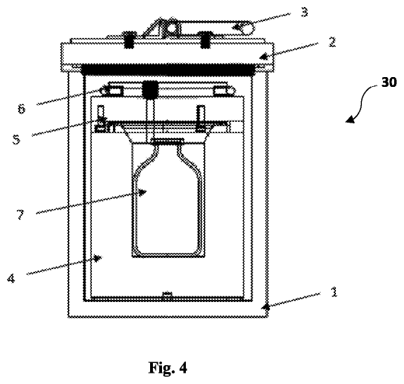

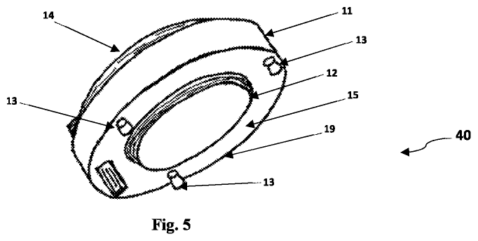

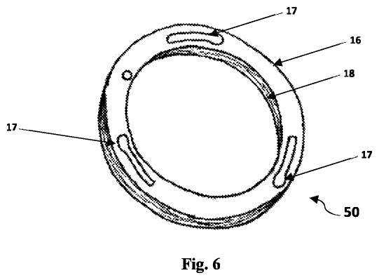

FIG. 3 and FIG. 4 show a diagram of a schematic representation of the entire arrangement of double shielded container (30) for transporting radiopharmaceutical drugs, which further encloses a vial (7) for transportation of a radiopharmaceutical drug. The double shielded container (30) comprises a primary shielding container (20) as shown in FIG. 2 and a secondary shielding container (10) as shown in FIG. 1. The secondary shielding container (10) as shown in FIG. 1 comprises secondary shield wall (1), which encloses the primary shielding container (20) in the cylindrical hollow space (8) as shown in FIG. 2 with a cap and closure (2) having a handle (3). The primary shielding container (20) as shown in FIG. 2 comprises a wall (4) having a cap and closure (5) along with a handle (6) as shown in FIG. 4, and further encloses a radiopharmaceutical drugs vial (7). The caps (2 and 5) are fitted to the shielded container walls (1 and 4) respectively via a collar (not shown in the figures). Further, the primary shielding container (20) and secondary shielding container (10) have cap and closure systems (2 and 5), which have recesses to fit the cap by a twist-locking system as shown in FIG. 5 and FIG. 6.

FIG. 5 illustrates a schematic representation of cap and closure system (40) of both the cap of primary shielding container (20) and secondary shielding container (10), wherein the cap and closure systems (2 and 5) comprise a cap wall (11); a top portion of the cap (14); a collar (12); flange (15) with a flange edge (19) and inner flanges (13), which further twist-lock with the recesses (17) as shown in FIG. 6.

FIG. 6 illustrates a schematic representation of a rim system (50) that comprises one or more recess (17), and a rim (16) along with the inner side of the rim (18). The inner flanges (13) of FIG. 5 are twist-locked with the recesses (17) as shown in FIG. 6 and tightly locked the cap and closure system (40) with the cylindrical shaped primary shielding container (20) and secondary shielding container (10) and secure the radiopharmaceutical drug vial inside the primary shielding container (20).

Each embodiment disclosed herein is contemplated as being applicable to each of the other disclosed embodiments. Thus, all combinations of the various elements described herein are within the scope of the invention. This invention will be better understood by reference to the experimental data, which follow, but those skilled in the art will be readily appreciated that the specific experiments detailed are only illustrative of the invention as described more fully in the claims, which follow thereafter.

Future works will extend this framework for deriving other relevant designs and structure to enhance the safety features and improve the quality of radiation shielding during manufacturing, process, handling and transportation.

What is claimed:

1. An integrated double shielded container for transporting radiopharmaceutical drugs, comprising:
a primary shielding container with a closure cap and a handle; and
a secondary shielding container with a closure cap and a handle;
wherein the secondary shielding container encloses the primary shielding container;
wherein the primary shielding container further encloses a radiopharmaceutical drug vial configured to contain a radiopharmaceutical dose in the vial;
wherein the secondary shielding container comprises a monitoring system to monitor the double shielded container for the transportation of radiopharmaceutical drugs;
wherein the monitoring system is selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking; and
wherein the double shielded container is accommodated within an impact absorbing intermediate structure to protect the radiopharmaceutical drug containing vial or pre-filled syringe during transport.

2. The double shielded container for transporting radiopharmaceutical drugs according to claim 1, wherein at least a portion of the secondary shielding container is surrounded with an impact absorbing intermediate structure.

3. The double shielded container for transporting radiopharmaceutical drugs according to claim 2, wherein the impact absorbing intermediate structure is a foam packing structure and further enclosed in a transporting box.

4. The double shielded container for transporting radiopharmaceutical drugs according to claim 1, wherein the primary shielding container comprises a closure cap, a collar, and a rim.

5. The double shielded container for transporting radiopharmaceutical drugs according to claim 4, wherein the collar comprises one or more flange and the rim comprises one or more recesses.

6. The double shielded container for transporting radiopharmaceutical drugs according to claim 4, wherein the recess is designed to releasably engage with the flange.

7. The double shielded container for transporting radiopharmaceutical drugs according to claim 4, wherein the flange functions as a twist-lock element that is received by twist-lock recesses in the flange of the primary shielding container; and wherein the twist-lock recesses, when twisted, is configured to secure the closure cap in a locked configuration tightly to the primary shielding container.

8. The double shielded container for transporting radiopharmaceutical drugs according to claim 1, wherein the double shielded container is compliant to one or more of the quality tests selected from the group consisting of freefall drop and shock testing, vibration testing, concentrated impacts testing, compression testing, incline impact testing, cold chain testing for temperature and humidity inputs, high and low pressure inputs testing, loose load or mechanical bounce testing, and rough forklift handling testing.

9. The double shielded container for transporting radiopharmaceutical drugs according to claim 2, wherein the transporting box is made of a hard plastic material.

10. The double shielded container for transporting radiopharmaceutical drugs according to claim 9, wherein the hard plastic material is selected from the group consisting of vinyl polymer, polyamide-imide (PAI), polyether ether ketone (PEEK), polyphenylene sulfide (PPS), nylon, high-density polyethylene (HDPE), polycarbonate (PC), or combinations thereof.

11. The double shielded container for transporting radiopharmaceutical drugs according to claim 1, wherein the shield is made of lead, lead glass, tungsten, cast-iron, lead-containing plastic material, tantalum, charged compound, leaded acrylic/plastic, lead-free acrylic, bismuth, a combination of stainless steel, aluminum alloy and tungsten, or combinations thereof.

12. The double shielded container for transporting radiopharmaceutical drugs according to claim 1, wherein the primary shielding container and secondary shielding container is in the shape of a cylindrical shell.

13. The double shielded container for transporting radiopharmaceutical drugs according to claim 1, wherein the primary shielding container is in the shape of a cylindrical shell with an interior diameter that is only slightly larger than an outer diameter of the vial that is to be placed into the primary shielding container.

14. The double shielded container for transporting radiopharmaceutical drugs according to claim 1, wherein the secondary shielding container is in the shape of a cylindrical shell with an interior diameter that is slightly larger than the inner diameter of the primary shielding container to be enclosed.

15. The double shielded container for transporting radiopharmaceutical drugs according to claim 13, wherein the diameter of the primary shielding container ranges from about 3 inches to about 5 inches.

16. The double shielded container for transporting radiopharmaceutical drugs according to claim 14, wherein the diameter of the secondary shielding container ranges from about 4 inches to about 6 inches.

17. A double shielded container for transporting radiopharmaceutical drugs, comprising:
a primary shielding container with a closure cap and a handle;
a secondary shielding container with a closure cap and a handle; and
an impact absorbing intermediate structure to accommodate the double shielded container;
wherein the secondary shielding container encloses the primary shielding container;
wherein the primary shielding container further encloses a radiopharmaceutical drug dose vial configured to contain a radiopharmaceutical drug dose within the vial; and
wherein the secondary shielding container comprises a monitoring system to monitor the double shielded container for the transportation of radiopharmaceutical drugs.

18. The double shielded container for transporting radiopharmaceutical drugs according to claim 17, wherein the monitoring system is selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking.

19. The double shielded container for transporting radiopharmaceutical drugs according to claim 17, wherein the secondary shielding container comprises an encoded information.

20. An integrated transporting box for transportation of radiopharmaceutical drugs, comprising a double shielded container, comprises:
a primary shielding container with a cap and a handle on the cap;
a secondary shielding container with a cap and a handle to lift; and
an impact absorbing intermediate structure;
wherein the primary shielding container is enclosed within the secondary shielding container, and at least a portion of the secondary shielding container is surrounded with the impact absorbing intermediate structure to protect the radiopharmaceutical drug containing vial or pre-filled syringe during transport and is further enclosed in the transporting box;
wherein the primary shielding container further encloses a radiopharmaceutical drug dose vial configured to contain a radiopharmaceutical drug dose in the vial;
wherein the secondary shielding container comprises a monitoring system to monitor the transporting shielding system;
wherein the monitoring system comprising one or more components selected from the group consisting of sensors, wireless transmitter systems, RFID systems, tags, small devices with a microchip and antenna, barcodes, QR codes, bluetooth low energy (BLE), near-field communication (NFC), Wi-Fi, ultra-wide band (UWB), and GPS Tracking; and
wherein the double shielded container is compliant to one or more quality tests selected from the group consisting of freefall drop and shock testing, vibration testing, concentrated impacts testing, compression testing, incline impact testing, cold chain testing for temperature and humidity inputs, high and low pressure inputs testing, loose load or mechanical bounce testing, rough forklift handling testing and combinations thereof.
